(19) United States
(12) Patent Application Publication
(10) Pub. No.: US 2023/0056154 A1
(43) Pub. Date: Feb. 23, 2023

(54) SERVER DEVICE, CONFERENCE ROOM MANAGEMENT METHOD, AND PROGRAM RECORDING MEDIUM

(71) Applicant: NEC Corportion, Minato-ku, Tokyo (JP)

(72) Inventors: Shin Norieda, Tokyo (JP); Kenta Fukuoka, Tokyo (JP); Masashi Yoneda, Tokyo (JP); Shogo Akasaki, Tokyo (JP)

(73) Assignee: NEC Corporation, Minato-ku, Tokyo (JP)

(21) Appl. No.: 17/799,368

(22) PCT Filed: Feb. 28, 2020
(86) PCT No.: PCT/JP2020/008521

§ 371 Date: Aug. 12, 2022

(51) Int. Cl. H04L 12/18; G06F 21/32

(52) U.S. Cl. CPC H04L 12/1818; H04L 12/1822; G06F 21/32

(57) ABSTRACT

The server device includes: a conference reservation database; a conference room management unit; and an authentication request processing unit. The conference reservation database stores the date and time of a conference, the IDs of participants participating in the conference, and the contact information on the participants in association with each other. The conference room management unit selects a conference room to be used for the conference from among a plurality of conference rooms and notifies the participants of the ID of the selected conference room before the date and time of the conference. The authentication request processing unit receives an authentication request for the visitor of the selected conference room from a terminal that controls the entry and exit of the selected conference room, processes the received authentication request, and transmits the authentication result for the visitor to the terminal.

### TECHNICAL FIELD

The present invention relates to a server device, a conference room management system, a conference room management method, and a program.

### BACKGROUND ART

Conferences are important in activities in companies and the like. For example, Patent Literature 1 discloses that it is possible to reduce a procedure burden on a person in charge and a visitor and improve efficiency of management of a schedule and reception.

The acceptance management device disclosed in Patent Literature 1 includes a storage unit, an acquisition unit, an acceptance unit, a generation unit, a transmission unit, a reception unit, and an acceptance processing unit. The storage unit stores conference reservation information and visit reservation information including association between a person in charge and a visitor who visits the person in charge. The acquisition unit acquires schedule information of the person in charge. The acceptance unit receives input of destination information of data to the visitor and candidate date and time as a setting candidate of the conference. The generation unit generates schedule adjustment request information including the candidate date and time. The transmission unit transmits the request information to the destination indicated by the destination information of the visitor. The reception unit receives a confirmation notification indicating that the reservation of the conference at the candidate date and time included in the request information is confirmed. The acceptance processing unit performs reservation registration of the vacant conference room indicated by the conference reservation information at the candidate date and time indicated by the confirmation notification, and updates the schedule information and the visit reservation information.

### CITATION LIST

### Patent Literature

[PTL 1] JP 2020-003941 A

### SUMMARY OF INVENTION

### Technical Problem

As described above, conferences in companies and the like are important as a place for decision-making and the like. In order to hold a conference, it is necessary to secure (reserve) a conference room, but there is a case where a necessary conference room cannot be reserved. For example, a situation may occur in which a conference room equal to or larger than the number of participants participating in a conference is reserved, and a conference room for holding a conference in which a large number of participants participate cannot be secured.

A main object of the present invention is to provide a server device, a conference room management system, a conference room management method, and a program that contribute to the efficient use of a conference room.

### Solution to Problem

According to a first aspect of the present invention, there is provided a server device including: a conference reservation database that stores in association with each other, a date and time of a conference, IDs of participants participating in the conference, and contact information of the participants; a conference room management unit that selects a conference room to be used for the conference from among a plurality of conference rooms before the date and time of the conference, and notifies the participants of an ID of the selected conference room; and an authentication request processing unit that receives an authentication request related to a visitor of the selected conference room from a terminal, the terminal controlling entrance and exit into and from the selected conference room, processes the received authentication request, and transmits an authentication result related to the visitor to the terminal.

According to a second aspect of the present invention, there is provided a conference room management system including: a terminal configured to control entrance and exit into and from a conference room; and a server device connected to the terminal, the server device including: a conference reservation database that stores a date and time of a conference, IDs of participants participating in the conference, and contact information of the participants in association with each other; a conference room management unit that selects a conference room to be used for the conference from among a plurality of conference rooms before the date and time of the conference, and notifies the participants of an ID of the selected conference room; and an authentication request processing unit that receives an authentication request related to a visitor of the terminal from the terminal, processes the received authentication request, and transmits an authentication result related to the visitor to the terminal.

According to a third aspect of the present invention, there is provided a conference room management method in a server device, the method including: storing in association with each other, a date and time of a conference, IDs of participants participating in the conference, and contact information of the participants; selecting a conference room to be used for the conference from among a plurality of conference rooms and notifying the participants of an ID of the selected conference room before the date and time of the conference; and receiving an authentication request related to a visitor of the selected conference room from a terminal that controls entrance and exit into and from the selected conference room, processing the received authentication request, and transmitting an authentication result related to the visitor to the terminal.

According to a fourth aspect of the present invention, there is provided a computer-readable storage medium storing a program for causing a computer mounted on a server device to execute: a process of storing in association with each other, a date and time of a conference, IDs of participants participating in the conference, and contact information of the participants; a process of selecting a conference room to be used for the conference from among a plurality of conference rooms and notifying the participants of an ID of the selected conference room before the date and time of the conference; and a process of receiving an authentication request related to a visitor of the selected conference room from a terminal that controls entrance and exit into and from the selected conference room, processing the received authentication request, and transmitting an authentication result related to the visitor to the terminal.

### Advantageous Effects of Invention

According to each aspect of the present invention, a server device, a conference room management system, a conference room management method, and a program that contribute to the efficient use of a conference room are provided. Note that the effect of the present invention is not limited to the above. According to the present invention, other effects may be exhibited instead of or in addition to the effects.

### BRIEF DESCRIPTION OF DRAWINGS

FIG. 1 is a diagram for describing an outline of an example embodiment.

FIG. 2 is a diagram illustrating an example of a schematic configuration of a conference room management system according to the first example embodiment.

FIG. 3 is a diagram illustrating an example of a processing configuration of the server device according to the first example embodiment.

FIG. 4 is a diagram illustrating an example of a processing configuration of a user registration unit according to the first example embodiment.

FIG. 5 is a diagram for explaining an operation of the user information acquisition unit according to the first example embodiment.

FIG. 6 is a diagram illustrating an example of a user database.

FIG. 7 is a diagram for describing an operation of a reservation information management unit according to the first example embodiment.

FIG. 8 is a diagram illustrating an example of a conference reservation database.

FIG. 9 is a diagram illustrating an example of a conference room management database.

FIG. 10 is a diagram illustrating an example of a processing configuration of the authentication terminal according to the first example embodiment.

FIG. 11 is a sequence diagram illustrating an example of operation of the conference room management system according to the first example embodiment.

FIG. 12 is a diagram illustrating an example of a hardware configuration of a server device.

### EXAMPLE EMBODIMENT

First, an outline of an example embodiment will be described. Note that the reference numerals in the drawings attached to this outline are attached to each element for convenience as an example for assisting understanding, and the description of this outline is not intended to be any limitation. In addition, in a case where there is no particular explanation, the block described in each drawing represents not a configuration of a hardware unit but a configuration of a functional unit. Connection lines between blocks in each drawing include both bidirectional and unidirectional lines. The unidirectional arrow schematically indicates a flow of a main signal (data), and does not exclude bidirectionality. Note that, in the present specification and the drawings, elements that can be similarly described are denoted by the same reference numerals, and redundant description can be omitted.

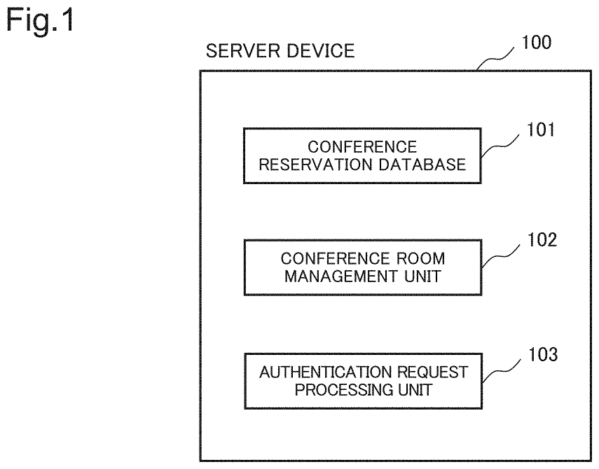

A server device 100 according to the example embodiment includes a conference reservation database 101, a conference room management unit 102, and an authentication request processing unit 103 (see FIG. 1). The conference reservation database 101 stores the date and time of a conference, IDs of participants participating in the conference, and contact information of the participants in association with each other. The conference room management unit 102 selects a conference room to be used for the conference from among a plurality of conference rooms before the date and time of the conference, and notifies the participants of the ID of the selected conference room. The authentication request processing unit 103 receives an authentication request related to a visitor of the selected conference room from a terminal that controls entrance and exit into and from the selected conference room, processes the received authentication request, and transmits an authentication result related to the visitor to the terminal.

The server device 100 receives information related to reservation of a conference room from a user of the system. The information related to the reservation of the conference room (conference reservation information) includes the date and time of the conference, but does not include information specifying the conference room such as the number of the conference room. When the conference time arrives, the server device 100 selects a conference room for holding the conference, and notifies the conference participants of information (conference room ID; for example, the number of the conference room) for specifying the selected conference room. The participant who has received the notification goes to a designated conference room and receives authentication via a terminal that manages the conference room. When the authentication succeeds, a visitor of the terminal (a participant who has received the conference room ID) can enter the conference room. As described above, in the conference room management system including the server device 100, the conference room itself is not reserved, and the server device 100 automatically selects the conference room suitable for the conference to be held and notifies the participants of the selected conference room. As a result, the inconvenience that an unnecessarily large conference room is used is eliminated, and the efficient use of the conference room is achieved.

Hereinafter, specific example embodiments will be described in more detail with reference to the drawings. [First Example embodiment]

A first example embodiment will be described in more detail with reference to the drawings.

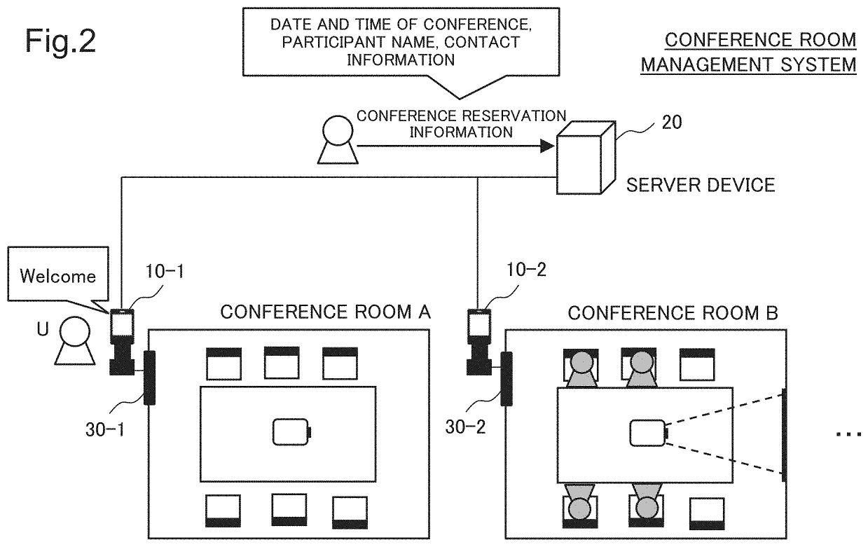

FIG. 2 is a diagram illustrating an example of a schematic configuration of a conference room management system according to the first example embodiment. Referring to FIG. 2, authentication terminals 10-1 and 10-2 installed in a plurality of conference rooms, respectively, and a server device 20 are included.

In the following description, when there is no particular reason to distinguish the authentication terminals 10-1 and 10-2, they are simply referred to as “authentication terminals 10”. Similarly, for other components, reference numerals on the left side separated by hyphens are used to represent the components.

The devices illustrated in FIG. 2 are connected to each other. For example, the authentication terminal 10 and the server device 20 are connected by wired or wireless communication means, and are configured to be able to communicate with each other.

Note that the server device 20 may be installed in the same building as the conference rooms A and B, or may be installed on a network (on a cloud).

The authentication terminal 10 is a terminal installed at the entry of a conference room. The authentication terminal 10 controls (manages) entrance and exit of the conference user into and from the conference room, particularly, entry into the conference room.

The authentication terminal 10 is connected to a gate 30. When the authentication of the visitor is successful, the authentication terminal 10 opens the gate 30 and permits the visitor to enter the conference room.

In addition, the authentication terminal 10 can display information related to a conference being held in addition to the authentication function (opening/closing control of the gate 30). For example, the authentication terminal 10 displays names of attendees of the conference, and displays a purpose, an agenda, and the like of the conference.

The server device 20 is a device that implements a conference room management system. The server device 20 performs control related to use of a conference room to be managed. Specifically, the server device 20 receives conference reservation information from the user.

The server device 20 selects a conference room suitable for the reserved conference, and notifies the user (participant to the conference) of the selected conference room. In addition, the server device 20 manages the usage status of the conference room.

The server device 20 acquires information (hereinafter referred to as conference reservation information) regarding reservation of a conference to be held in the future. Specifically, the server device 20 acquires, from the conference reserver, “conference reservation information” including the date and time of the conference, information (for example, the name) for specifying the conference participant, the contact information of the conference participant, and the like.

When the conference date and time described in the conference reservation information arrives, the server device 20 allocates the conference room to be used in the conference of the conference reservation information. For example, in the example of FIG. 2, a case where a conference reserver inputs conference reservation information to the server device 20 will be considered. In this case, the server device 20 selects the place where the conference is held immediately before the conference date and time input by the conference reserver. In the example of FIG. 2, the conference room A is selected.

The server device 20 notifies the conference participants of information of the selected conference room A (information for specifying conference room A; conference room ID, for example, conference room number).

The conference participants go to the conference room A selected according to the notification. The conference participant moves in front of the authentication terminal 10-1. The authentication terminal 10-1 acquires the biometric information of the visitor in front (conference participant), and transmits an “authentication request” including the acquired biometric information (for example, a face image) to the server device 20.

The server device 20 extracts the biometric information from the received authentication request, and specifies the ID of the visitor (user ID to be described later) by collation processing using the biometric information. The server device 20 verifies whether the specified user ID has the authority to use the conference room A managed by the authentication terminal 10-1 that is the transmission source of the authentication request.

When determining that the visitor has authority to use the conference room A, the server device 20 transmits “successful authentication” to the authentication terminal 10-1. When determining that the visitor does not have authority to use the conference room A, the server device 20 transmits “failed authentication” to the authentication terminal 10-1.

If the response from the server device 20 is “successful authentication”, the authentication terminal 10-1 opens the gate 30-1 and permits the visitor to use the conference room. If the response from the server device 20 is “failed authentication”, the authentication terminal 10-1 does not open the gate 30-1 and displays the fact that the visitor does not have the authority to use the conference room.

In this manner, the server device 20 automatically selects a conference room to be used for the conference to be held from among the plurality of conference rooms before the date and time of the conference, and notifies the conference participants of the ID of the selected conference room. The server device 20 receives an authentication request related to a visitor of the authentication terminal 10 from the authentication terminal 10, and transmits an authentication result related to the visitor to the authentication terminal 10. Further, the authentication request transmitted by the authentication terminal 10 includes biometric information of the visitor. The server device 20 executes collation processing using the biometric information extracted from the authentication request and the biometric information stored in a database (user database to be described later). Through the collation processing, the use authority of the visitor (whether the visitor has the authority to use the conference room) is determined.

Note that the configuration of the conference room management system illustrated in FIG. 2 is an example and is not intended to limit the configuration of the system. For example, although the authentication terminal 10 and the gate 30 are illustrated separately in FIG. 2, they may be integrated.

### <Preliminary Preparation>

In order for the conference participants to use the conference room, the system users (users scheduled to participate in the conference) need to make preparations in advance. The preliminary preparation will be described below.

The preliminary preparation performed by the system user includes two preparations.

The first preliminary preparation is to register information related to the user himself/herself in the system.

The second preliminary preparation is that the user registers the conference reservation information in the system. <First Preliminary Preparation; System User Registration>

The user registers attribute values such as his/her biometric information and profile in the system. Specifically, the user inputs the face image to the server device 20. In addition, the user inputs his/her profile (for example, information such as a name, an employee number, a place of employment, a department, a position, and a contact information) to the server device 20.

Note that any method can be used to input information such as the biometric information and the profile. For example, the user captures his/her face image using a terminal such as a smartphone. Further, the user generates a text file or the like in which the profile is described using the terminal. The user operates the terminal to transmit the information (face image and profile) to the server device 20. Alternatively, the user may input necessary information to the server device 20 using an external storage device such as a universal serial bus (USB) in which the information is stored.

Alternatively, the server device 20 may have a function as a web server, and the user may input necessary information using a form provided by the server.

The server device 20 updates the database that manages the system user using the acquired user information (attribute value of user; biometric information, profile, and the like). Details regarding the update of the database will be described later, but the server device 20 updates the database by the following operation. Note that, in the following description, a database for managing users using the system of the present disclosure will be referred to as a “user database”.

When the person associated to the acquired user information is a new user not registered in the user database, the server device 20 assigns an identifier (ID) to the user. In addition, the server device 20 generates a feature that characterizes the acquired face image.

The server device 20 adds an entry including the ID assigned to the new user, the feature generated from the face image, the face image of the user, the profile, and the like to the user database. When the server device 20 registers the user information, the system user can use the conference room illustrated in FIG. 2.

### <Second Preliminary Preparation; Input of Conference Reservation Information>

As described above, the user inputs the conference reservation information to the server device 20. Specifically, the user inputs “conference reservation information” including the date and time of the conference, the name of the conference participant, the contact information of the conference participant, and the like to the server device 20.

The user inputs the conference reservation information to the server device 20 by an arbitrary method. For example, the user may input the conference reservation information to the server device 20 using his/her terminal, or may input the information to the server device 20 using a GUI or the like provided by the server device 20.

Next, details of each device included in the conference room management system according to the first example embodiment will be described. [Server Device]

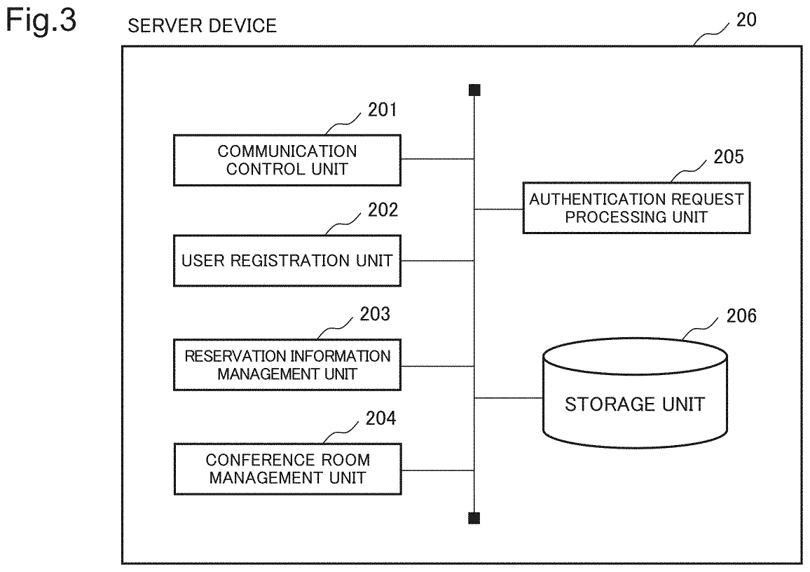

FIG. 3 is a diagram illustrating an example of a processing configuration (processing module) of the server device 20 according to the first example embodiment. Referring to FIG. 3, the server device 20 includes a communication control unit 201, a user registration unit 202, a reservation information management unit 203, a conference room management unit 204, an authentication request processing unit 205, and a storage unit 206.

The communication control unit 201 is a unit that controls communication with other devices. Specifically, the communication control unit 201 receives data (packets) from the authentication terminal 10. In addition, the communication control unit 201 transmits data to the authentication terminal 10. The communication control unit 201 delivers data received from another device to another processing module. The communication control unit 201 transmits data acquired from another processing module to another device. In this manner, the other processing modules transmit and receive data to and from other devices via the communication control unit 201.

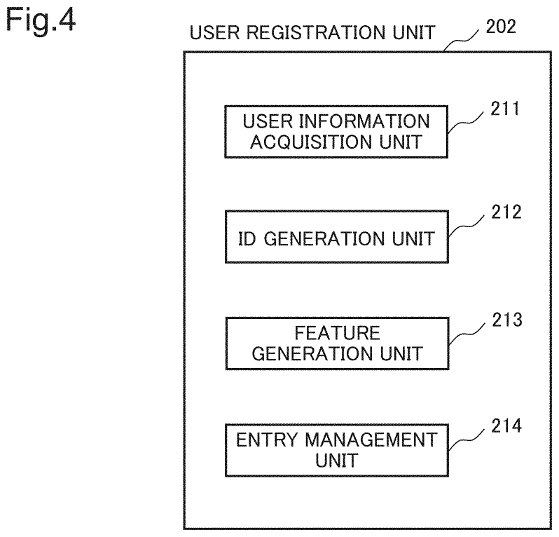

The user registration unit 202 is a unit that realizes the system user registration described above. The user registration unit 202 includes a plurality of submodules. FIG. 4 is a diagram illustrating an example of a processing configuration of the user registration unit 202. Referring to FIG. 4, the user registration unit 202 includes a user information acquisition unit 211, an ID generation unit 212, a feature generation unit 213, and an entry management unit 214.

The user information acquisition unit 211 is a unit that acquires the user information described above. The user information acquisition unit 211 acquires biometric information and profiles of a plurality of users using the conference room management system. More specifically, the user information acquisition unit 211 acquires biometric information (for example, a face image) and a profile (for example, name, department, and the like) of the system user. The system user may input the above information to the server device 20 from his/her terminal.

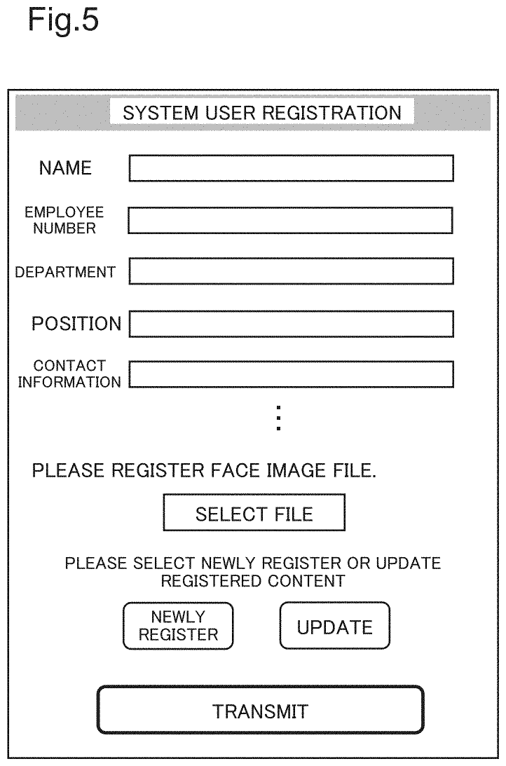

The user information acquisition unit 211 may provide a GUI or a form for inputting the information. For example, the user information acquisition unit 211 displays an information input form as illustrated in FIG. 5 on a terminal operated by the user.

The system user inputs the information illustrated in FIG. 5. In addition, the system user selects whether to newly register the user in the system or to update the already registered information. After inputting all the information, the system user presses the “transmit” button, and inputs the biometric information and the profile to the server device 20.

The user information acquisition unit 211 stores the acquired user information in the storage unit 206.

The ID generation unit 212 is a unit that generates an ID to be assigned to the system user. When the user information input by the system user is information related to new registration, the ID generation unit 212 generates an ID for identifying the new user. For example, the ID generation unit 212 may calculate a hash value of the acquired user information (face image, profile) and use the hash value as an ID to be assigned to the user. Alternatively, the ID generation unit 212 may assign a unique value each time user registration is performed and use the assigned value as the ID. In the following description, an ID (an ID for identifying a system user) generated by the ID generation unit 212 is referred to as a “user ID”.

The feature generation unit 213 is a unit that generates a feature (a feature vector including a plurality of features) characterizing the face image from the face image included in the user information. Specifically, the feature generation unit 213 extracts feature points from the acquired face image. Note that an existing technique can be used for the feature point extraction processing, and thus a detailed description thereof will be omitted. For example, the feature generation unit 213 extracts eyes, a nose, a mouth, and the like as feature points from the face image. Thereafter, the feature generation unit 213 calculates the position of each feature point and the distance between the feature points as a feature, and generates a feature vector (vector information characterizing the face image) including a plurality of features.

The entry management unit 214 is a unit that manages an entry of the user database. When registering a new user in the database, the entry management unit 214 adds an entry including the user ID generated by the ID generation unit 212, the feature generated by the feature generation unit 213, the face image, and the profile acquired from the user to the user database.

When updating the information of the user already registered in the user database, the entry management unit 214 specifies an entry to be subjected to the information update based on the employee number or the like, and updates the user database using the acquired user information. At that time, the entry management unit 214 may update a difference between the acquired user information and the information registered in the database, or may overwrite each item of the database with the acquired user information. Similarly, regarding the feature, the entry management unit 214 may update the database when there is a difference in the generated feature, or may overwrite the existing feature with the newly generated feature.

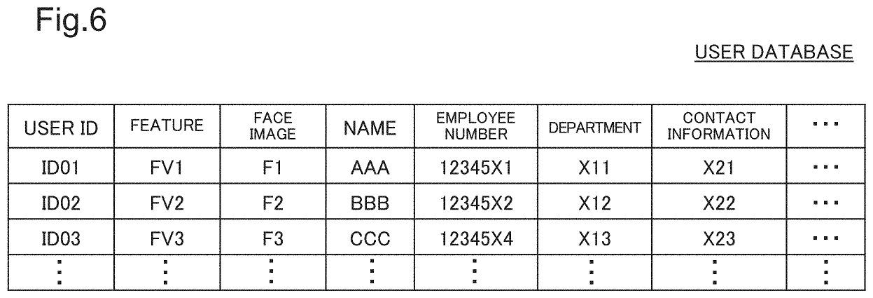

The user registration unit 202 operates to construct a user database (database in which user ID for identifying system user, biometric information, and profile are stored in association with each other) as illustrated in FIG. 6. The user database stores at least the biometric information of each of the plurality of users and the user ID in association with each other. Naturally, the content registered in the user database illustrated in FIG. 6 is an example and is not intended to limit the information registered in the user database.

The description returns to FIG. 3. The reservation information management unit 203 is a unit that acquires “conference reservation information” from the user before the conference is held. The reservation information management unit 203 acquires conference reservation information from a system user (a user scheduled to participate in a conference to be held in the future). For example, the user may input the conference reservation information to the server device 20 from his/her terminal, or may directly operate the server device 20 to input the above information.

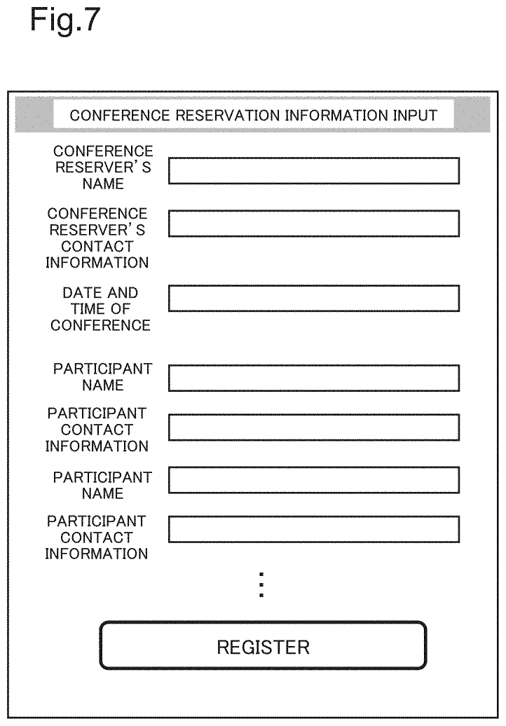

The reservation information management unit 203 may provide a graphical user interface (GUI) or a form for inputting the conference reservation information. For example, the reservation information management unit 203 displays an information input form as illustrated in FIG. 7 on the terminal operated by the user.

Referring to FIG. 7, information related to the conference reserver (conference reserver's name, conference reserver's contact information) and information related to the conference participant (participant name, participant contact information) are registered in the system. In addition, the date and time of the conference is registered in the system.

Note that, in a case where the server device 20 provides the information input form as illustrated in FIG. 7, the reservation information management unit 203 may acquire information of the contact information of the participant and the conference reserver from the user database and assist the conference reserver to input the information. Specifically, the reservation information management unit 203 searches the user database using the name of the conference reserver and the name of the conference participant as keys, and specifies the associated contact information (for example, an e-mail address). The reservation information management unit 203 may display the specified contact information in the associated input field.

The information input form as illustrated in FIG. 7 is a display on the premise that the conference reserver and the participant are different. In a case where the conference reserver also participates in the conference, the name (the name of the conference reserver) and the contact information are input to the participant name and the participant contact information.

When the input of the information as illustrated in FIG. 7 is completed, the user presses the “register” button. In response to the pressing of the button, the server device 20 acquires conference reservation information.

The reservation information management unit 203 generates a conference ID from the acquired conference reservation information. For example, the reservation information management unit 203 may calculate a hash value of the acquired conference reservation information to use the hash value as the conference ID, or may assign a unique value every time the conference reservation information is registered to use the hash value as the conference ID.

The reservation information management unit 203 specifies the conference reserver's name and the user ID associated to the participant name input by the conference reservation information. Specifically, the reservation information management unit 203 searches the user database using the conference reserver's name and the like as a key, and specifies the associated user ID.

The reservation information management unit 203 manages reservation of a conference (reservation of a conference to be held in the future) using the “conference reservation database”. The reservation information management unit 203 adds an entry including fields such as the generated conference ID, the conference date and time, the number of conference participants, the user ID of the conference participants, and the contact information to the database. That is, the reservation information management unit 203 manages the conference ID, the date and time, the number of participants, the user ID, the contact information, and the like in association with each other.

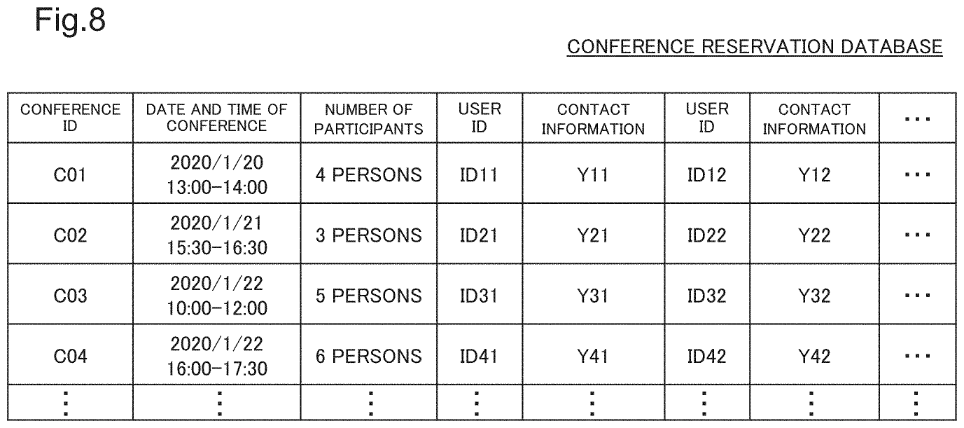

The reservation information management unit 203 constructs a conference reservation database as illustrated in FIG. 8. Note that the conference reservation database illustrated in FIG. 8 is an example and is not intended to limit the contents thereof. For example, the conference reservation database may include the user ID of the conference reserver. As illustrated in FIG. 8, the conference reservation database stores at least a date and time of a conference, IDs of participants participating in the conference, and contact information of the participants in association with each other. Note that the user ID illustrated in FIG. 8 and the user ID in the user database are the same type of information. The user ID stored in the user database is transferred to the conference reservation database illustrated in FIG. 8.

The description returns to FIG. 3. The conference room management unit 204 is a unit that manages the conference room. Specifically, the conference room management unit 204 selects a conference room suitable for the conference reservation information input by the user. That is, the conference room management unit 204 allocates the conference room to the conference reservation information input by the user. The conference room management unit 204 notifies the conference participants of the allocated conference room (selected conference room).

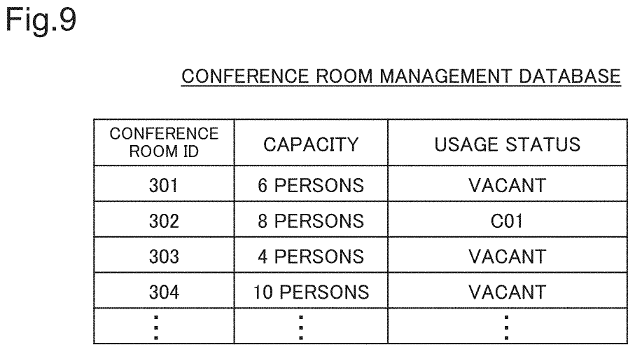

The conference room management unit 204 manages the conference room using a “conference room management database”. As illustrated in FIG. 9, the conference room management database includes fields in which an ID (hereinafter, referred to as a conference room ID) for specifying a conference room, the number of people that the conference room can accommodate, a use status of the conference room, and the like can be set. In the usage status field of the conference room, “vacant” is set if the conference room is not used, and the corresponding conference ID is set if the conference room is used. The conference room in which the conference ID is set is interpreted as “in use”. For example, in the example of FIG. 9, it can be seen that a conference having a conference ID of “C01” is being held in a conference room having a conference room ID of “302”.

In FIG. 9, the room number of the conference room is used as the conference room ID. Alternatively, as the conference room ID, an ID of the authentication terminal 10 that manages entrance and exit into and from each conference room may be used. For example, an Internet protocol (IP) address, a media access control (MAC) address, or the like of the authentication terminal 10 may be used as the conference room ID.

The conference room management database illustrated in FIG. 9 is an example, and other items may be managed (stored) by the database. For example, information (for example, the presence or absence of a projector, the presence or absence of a video conference system, and the like) regarding equipment provided in each conference room may be included in the conference room management database.

The conference room management unit 204 periodically refers to the date and time field of the conference reservation database, and specifies a conference whose date and time is approaching. Specifically, the conference room management unit 204 checks whether or not there is a conference scheduled to be held after a lapse of a predetermined time (for example, after 30 minutes) from the time of referring to the database.

When there is the conference scheduled to be held, the conference room management unit 204 reads the corresponding conference ID field and the field of the number of participants, and grasps the conference ID and the number of participants of the conference held most recently.

The conference room management unit 204 refers to the conference room management database, and selects a conference room suitable for a conference held most recently. Specifically, “vacant” is set in the usage status field, and the conference room management unit 204 selects a conference room capable of accommodating the predetermined number of participants of the conference held most recently. At that time, the conference room management unit 204 may select a conference room with a little room in the number of accommodating people, or may select a conference room capable of accommodating all the conference participants and having the smallest number of accommodating people.

The conference room management unit 204 sets the conference ID in the usage status field of the selected conference room. By setting the conference ID in the usage status field, the conference room is secured. That is, the conference room management unit 204 cannot allocate the conference room in which the conference ID is set in the usage status field to a conference with another conference ID.

When the setting of the conference ID is completed, the conference room management unit 204 notifies the conference participants who have secured the conference room of the place where the conference is held.

Specifically, the conference room management unit 204 generates “conference information” including the date and time of the conference, the room number of the conference room, the name of the participant, and the like, and notifies the contact information of the conference participant (an e-mail address described in the contact information field of the conference reservation database, or the like) of the conference information.

When the conference ends, the conference room management unit 204 sets “vacant” in the usage status field of the conference room management database. For example, a camera capable of imaging the inside of the conference room may be provided, and the conference room management unit 204 may grasp the end of the conference by analyzing an image obtained from the camera. Alternatively, the conference room management unit 204 may receive an explicit notification regarding the end of the conference from the participant and grasp the end of the conference. Alternatively, the conference room management unit 204 may notify each conference participant when the conference end time described in the conference reservation information arrives, and end the conference with the notification.

The description returns to FIG. 3. The authentication request processing unit 205 is a unit that processes an authentication request acquired from the authentication terminal 10. The authentication request processing unit 205 acquires an authentication request from the authentication terminal 10. Since the authentication request includes the face image of the visitor (person to be authenticated), the authentication request processing unit 205 extracts the face image from the authentication request. The authentication request processing unit 205 calculates a feature from the acquired face image.

The authentication request processing unit 205 sets the feature calculated based on the face image acquired from the authentication terminal 10 as a collation target, and performs the collation processing with the feature registered in the user database. More specifically, the authentication request processing unit 205 sets the calculated feature (feature vector) as a collation target, and executes one-to-N collation (N is a positive integer, and the same applies hereinafter) with a plurality of feature vectors registered in the user database.

The authentication request processing unit 205 calculates similarity between the feature of the collation target and each of the plurality of features on the registration side. A chi-square distance, a

Euclidean distance, or the like can be used as the similarity. Note that the farther the distance, the lower the similarity, and the closer the distance, the higher the similarity.

The authentication request processing unit 205 specifies the user IDs having the features having the highest similarity and the similarity with the feature of the collation target greater than or equal to a predetermined value among the plurality of features registered in the user database.

The authentication request acquired from the authentication terminal 10 includes a conference room ID (an ID of a conference room where the authentication terminal 10 manages entrance and exit of a user). The authentication request processing unit 205 acquires the conference room ID from the authentication request. The authentication request processing unit 205 refers to the conference room management database, and checks the usage status field of the acquired conference room ID.

If “vacant” is set in the usage status field, the authentication request processing unit 205 sets “failed authentication” since the user who has visited the conference room does not have authority to use the conference room.

When “conference ID” is set in the usage status field, the authentication request processing unit 205 refers to the conference reservation information database and checks the user ID field of the set conference ID. If the user ID specified by the collation processing is described in the user ID field of the conference reservation database, the authentication request processing unit 205 determines that the user (the visitor of the authentication terminal 10) has authority to use the conference room, and sets “successful authentication”. If the user ID specified by the collation process is not described in the user ID field of the conference reservation database, the authentication request processing unit 205 determines that the user does not have the authority to use the conference room and sets “failed authentication”.

In this manner, the authentication request processing unit 205 specifies the ID of the visitor of the authentication terminal 10 by the collation processing using the biometric information extracted from the authentication request and the biometric information stored in the user database. When the ID of the identified visitor is stored in the conference reservation database, the authentication request processing unit 205 determines that the visitor has authority to use the conference room (the conference room selected by the server device 20). When it is determined that the visitor has authority to use the conference room, the authentication request processing unit 205 notifies the authentication terminal 10 of “successful authentication”. On the other hand, when it is determined that the visitor does not have authority to use the conference room, the authentication request processing unit 205 notifies the authentication terminal 10 of “failed authentication”.

The authentication request processing unit 205 transmits an authentication result (successful authentication or failed authentication) to the authentication terminal 10 which is a transmission source of the authentication request. At that time, the authentication request processing unit 205 may transmit not only the authentication result but also information (name and the like) of the user who has succeeded in authentication and details of the conference (the date and time of the conference and the names of other participants) to the authentication terminal 10 as the transmission source. Note that the name of the user who has succeeded in authentication, the name of another participant, and the like are obtained by referring to the conference reservation database or the conference room management database.

When executing the collation processing, the authentication request processing unit 205 also notifies the conference room management unit 204 of the result of the collation processing. The conference room management unit 204 periodically refers to the usage status field of the conference room management database, and checks whether the conference ID is set in the field and whether the authentication of the participant participating in the conference of the conference ID is successful. The conference room management unit 204 cancels the reservation associated to the conference ID in a case where the conference ID is set in the usage status field and the authentication of the participant has never succeeded even after a lapse of a predetermined period from the conference time. Specifically, the conference room management unit 204 deletes the conference ID (a conference ID of a conference which is reserved but whose participants are not authenticated) set in the usage status field of the conference room management database. As a result, it is possible to eliminate the presence of unused conference rooms while the conference rooms are reserved.

The storage unit 206 is a unit that stores information necessary for the operation of the server device 20.

### [Authentication Terminal]

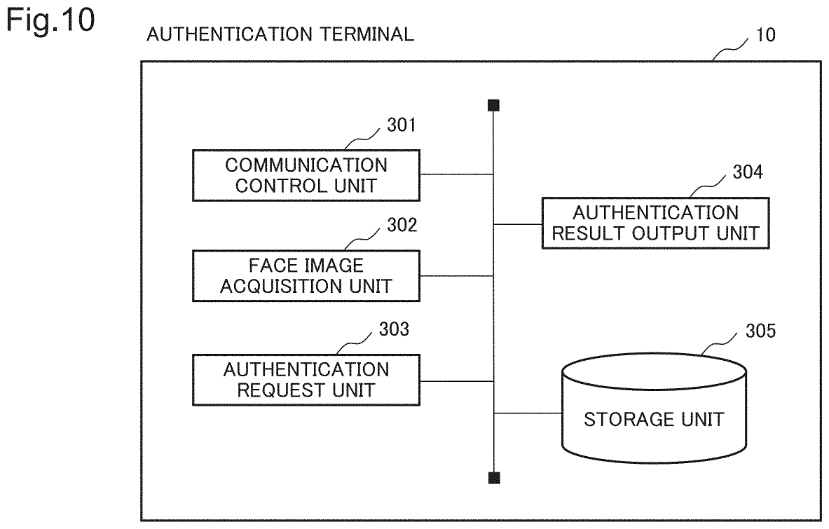

FIG. 10 is a diagram illustrating an example of a processing configuration (processing module) of the authentication terminal 10.

Referring to FIG. 10, the authentication terminal 10 includes a communication control unit 301, a face image acquisition unit 302, an authentication request unit 303, an authentication result output unit 304, and a storage unit 305.

The communication control unit 301 is a unit that controls communication with other devices. Specifically, the communication control unit 301 receives data (packets) from the server device 20. Furthermore, the communication control unit 301 transmits data to the server device 20. The communication control unit 301 delivers data received from another device to another processing module. The communication control unit 301 transmits data acquired from another processing module to another device. In this manner, the other processing modules transmit and receive data to and from other devices via the communication control unit 301.

The face image acquisition unit 302 is a unit that controls a camera device (a camera device included in the authentication terminal 10) and acquires a face image (biometric information) of a visitor in front. The face image acquisition unit 302 images the front of the own device periodically or at a predetermined timing. The face image acquisition unit 302 determines whether a face image of a person is included in the acquired image, and extracts the face image from the acquired image data when the face image is included.

Note that, since an existing technology can be used for the face image detection processing and the face image extraction processing by the face image acquisition unit 302, detailed description thereof will be omitted. For example, the face image acquisition unit 302 may extract a face image (face area) from image data using a learning model learned by a convolutional neural network (CNN). Alternatively, the face image acquisition unit 302 may extract the face image using a method such as template matching.

The face image acquisition unit 302 delivers the extracted face image to the authentication request unit 303.

The authentication request unit 303 is a unit that requests the server device 20 to authenticate a visitor in front. The authentication request unit 303 generates an authentication request and transmits the authentication request to the server device 20. The authentication request unit 303 generates an authentication request including the face image acquired from the face image acquisition unit 302 and the conference room ID of the conference room where the device manages entrance and exit. For example, in the example of FIG. 2, the authentication request unit 303 of the authentication terminal 10-1 generates an authentication request including the face image of the user U and the conference room ID of the conference room A.

The authentication request unit 303 receives a response (successful authentication or failed authentication) to the authentication request from the server device 20. The authentication request unit 303 delivers the response acquired from the server device 20 to the authentication result output unit 304.

The authentication result output unit 304 performs output according to the authentication result. For example, when the authentication result is “successful authentication”, the authentication result output unit 304 displays a message welcoming the visitor. When the authentication result is “failed authentication”, the authentication result output unit 304 displays the fact.

The storage unit 305 is a unit that stores information necessary for the operation of the authentication terminal 10. [Operation of Conference Room Management System]

Next, an operation of the conference room management system according to the first example embodiment will be described.

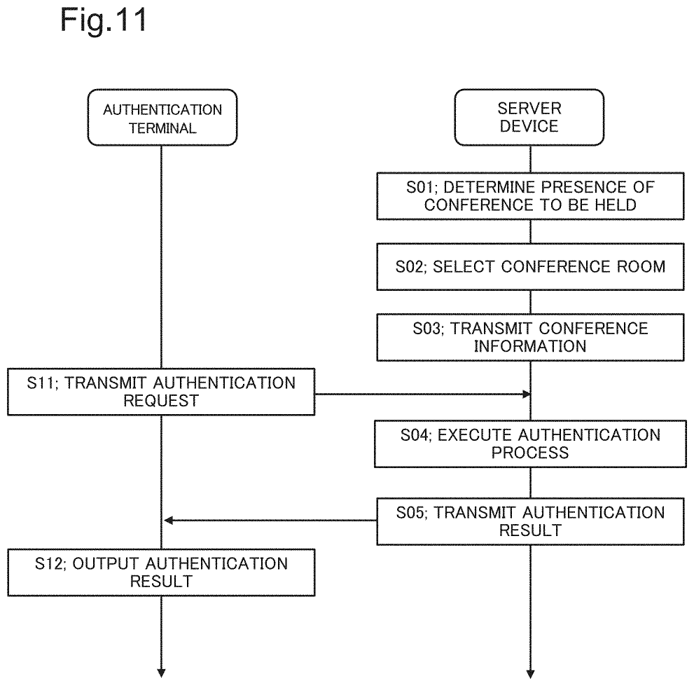

FIG. 11 is a sequence diagram illustrating an example of the operation of the conference room management system according to the first example embodiment. Note that FIG. 11 is a sequence diagram illustrating an example of a system operation in a case where the authentication terminal 10 permits a visitor to enter a room. It is assumed that the system user and the conference reservation information are registered in advance prior to the operation of FIG. 11.

The server device 20 checks the date and time field of the conference reservation database periodically or at a predetermined timing, and determines the presence or absence of the latest conference (step S01). In other words, the server device 20 determines the presence or absence of a conference (conference reservation information) in which it is necessary to secure a conference room.

If there is a conference scheduled to be held most recently, the server device 20 selects a conference room to be used in the conference (step S02). For example, the server device 20 selects a conference room that can accommodate conference participants. That is, the server device 20 selects a conference room to be used for a conference held most recently from among a plurality of conference rooms on the basis of the number of participants participating in the conference.

The server device 20 stores information of the selected conference room (information for specifying the conference room; conference room ID) is notified to the participants of the conference. Specifically, the server device 20 transmits the “conference information” to a mail address (an address that can be checked by a smartphone or the like) of the participant registered in advance (step S03). The conference information includes the place of a conference room, the date and time of the conference, the name of a conference participant, and the like.

When the conference participant moves in front of the authentication terminal 10, the authentication terminal 10 acquires a face image of the visitor. The authentication terminal 10 transmits an authentication request including the face image and the conference room ID to the server device 20 (step S11).

The server device 20 executes collation processing using the acquired face image (collation processing using the feature registered in the user database) (step SO4). Specifically, the server device 20 refers to the conference room management database, and checks the usage status of the conference room associated to the conference room ID included in the authentication request. If the usage status of the conference room is “vacant”, the server device 20 sets the authentication result of the visitor to “failed authentication”.

If the conference ID is set in the usage status of the conference room associated to the conference room ID included in the authentication request, the server device 20 checks whether the visitor is registered as a participant of the conference associated to the conference ID. Specifically, the server device 20 refers to the conference reservation database and acquires the user ID of the entry associated to the conference

ID set in the usage status field of the conference room management database. When the acquired user ID includes the user ID of the visitor of the authentication terminal 10, the server device 20 sets the authentication result of the visitor to “successful authentication”. On the other hand, when the acquired user ID does not include the user ID of the visitor of the authentication terminal 10, the server device 20 sets the authentication result of the visitor to “failed authentication”.

The server device 20 transmits the authentication result to authentication terminal 10 (step S05).

The authentication terminal 10 receives the authentication result and performs display according to the authentication result (step S12). For example, the authentication terminal 10 displays a message welcoming the visitor when the successful authentication is received. Alternatively, when the failed authentication is received, the authentication terminal 10 displays a message indicating that the user cannot enter the conference room.

As described above, in the conference room management system according to the first example embodiment, the conference reservation information acquired by the server device 20 includes the date and time of the conference, but does not include information for specifying the conference room such as the number of the conference room. When the conference time arrives, the server device 20 selects a conference room for holding the conference, and notifies the conference participants of information (conference room ID; for example, the number of the conference room) for specifying the selected conference room. The participant who has received the notification goes to the designated conference room and receives authentication via the authentication terminal 10 that manages the conference room. If the authentication is successful, the visitor enters the conference room. As described above, in the conference room management system including the server device 20, the conference room itself is not reserved, and the server device 20 automatically selects the conference room suitable for the conference to be held and notifies the participants of the selected conference room. As a result, an unnecessarily large conference room is not reserved, and the efficient use of the conference room is achieved. In addition, even in a situation where a conference room is not available for a long time, the server device 20 can refer to the conference room management database and select a vacant conference room. From such a viewpoint as well, it is possible to efficiently operate the conference room.

In addition, as a factor that hinders the efficient use of a conference room, there is a situation in which a conference room is scheduled to be held and the conference room is initially reserved, but thereafter, only the reservation remains even though the conference is canceled for some reason. That is, the presence of a conference room that is reserved but not actually used is one of factors that make it difficult to secure the conference room. The conference room management system disclosed in the present application resets a conference room once secured to a usable conference room in a case where no participant visits the conference room even when the conference time comes. As a result, there is no conference room that is reserved but not actually used, and the efficient use of the conference room is achieved.

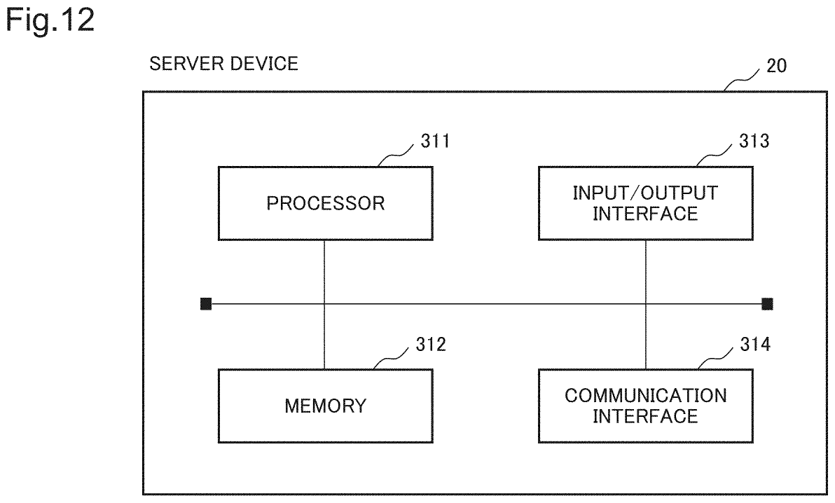

Next, hardware of each device constituting an entrance/exit management system will be described. FIG. 12 is a diagram illustrating an example of a hardware configuration of the server device 20.

The server device 20 can be configured by an information processing device (so-called a computer), and has the configuration illustrated in FIG. 12. For example, the server device 20 includes a processor 311, a memory 312, an input/output interface 313, a communication interface 314, and the like. The components such as the processor 311 are connected by an internal bus or the like, and are configured to be able to communicate with each other.

However, the configuration illustrated in FIG. 12 is not intended to limit the hardware configuration of the server device 20. The server device 20 may include hardware (not illustrated) or may not include the input/output interface 313 as necessary. In addition, the number of processors 311 and the like included in the server device 20 is not limited to the example of FIG. 12, and for example, a plurality of processors 311 may be included in the server device 20.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 is configured to execute various programs including an operating system (OS; Operating System).

The memory 312 is a random access memory (RAM), a read only memory (ROM), a hard disk drive (HDD), a solid state drive (SSD), or the like. The memory 312 stores an OS program, an application program, and various types of data.

The input/output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with another device. For example, the communication interface 314 includes a network interface card (NIC) or the like.

The functions of the server device 20 are implemented by various processing modules. The processing module is implemented, for example, by the processor 311 executing a program stored in the memory 312. Furthermore, the program can be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. Furthermore, the program can be downloaded via a network or updated using a storage medium storing the program. Further, the processing module may be implemented by a semiconductor chip.

Note that the authentication terminal 10 can also be configured by an information processing device similarly to the server device 20, and since there is no difference in the basic hardware configuration from the server device 20, the description thereof will be omitted. For example, the authentication terminal 10 may include a camera device, a liquid crystal display, or the like.

The server device 20 is equipped with a computer, and the function of the server device 20 can be implemented by causing the computer to execute a program. In addition, the server device 20 executes the conference room management method by the program. [Modified Example]

Note that the configuration, operation, and the like of the conference room management system described in the above example embodiment are merely examples, and are not intended to limit the configuration and the like of the system.

The profile of the system user (attribute value of the user) may be input using a scanner or the like. For example, the user inputs an image related to his/her business card to the server device 20 using a scanner. The server device 20 performs optical character recognition (OCR) processing is executed. The server device 20 may determine the profile of the user on the basis of the obtained information.

In the above example embodiment, the case where the biometric information related to the “face image” is transmitted from the authentication terminal 10 to the server device 20 has been described. However, the biometric information related to “the feature generated from the face image” may be transmitted from the authentication terminal 10 or the like to the server device 20. The server device 20 may execute the collation processing with the feature registered in the user database using the acquired feature (feature vector).

When detecting that the conference participant enters the conference room by the authentication request from the authentication terminal 10, the server device 20 may notify the remaining participants of the fact by an e-mail or the like.

When acquiring the conference reservation information, the server device 20 may reject the acquired conference reservation information in a case where there are many other conference reservation information in the period of the conference time designated by the reservation information. For example, if there are five conference rooms and there are six or more conferences scheduled to be held in the same period, the server device 20 may reject the sixth conference reservation information.

In the above example embodiment, the case where the server device 20 automatically selects the conference room in order to efficiently use the conference room on the premise that the conference reservation information is not canceled has been described. However, it is desirable to cancel the conference reservation information of the conference which is decided not to be held. When the conference reservation information is canceled, the server device 20 deletes the associated entry of the conference reservation database. In addition, in a case where the conference is canceled after the allocation of the conference room, the server device 20 sets “vacant” in the usage status field of the conference room management database associated to the allocated conference room.

The conference reservation information may include information on equipment scheduled to be used. In this case, the conference room management database includes information on equipment included in each conference room, and the server device 20 selects a conference room including the equipment described in the conference reservation information. For example, whether to use the projector is designated by the conference reservation information, and the server device 20 selects the conference room in which the projector is installed when selecting the conference room of the conference.

The server device 20 may select a conference room on the basis of management work such as cleaning of the conference room. For example, if a conference room close to a room where a cleaner of the conference room stays is preferentially allocated, a flow line of the cleaner is shortened, and efficient conference room management can be achieved. Alternatively, the server device 20 may select the conference room so that the use frequency is uniform. In this case, aged deterioration of each conference rooms becomes comparable, and quality of the conference room becomes constant.

Alternatively, by appropriately selecting the timing of securing the conference room (the timing at which the server device 20 secures the conference room), it is also possible to reduce the waiting time in a case where the participant arrives at the conference room early.

Alternatively, the timing at which the server device 20 selects the conference room may be designated when the conference reservation information is input. For example, in a case where an external participant is included, setting is performed such that the timing at which the server device 20 selects a conference room is early (for example, 30 minutes prior to the conference). On the other hand, in the case of an in-house conference, setting is performed such that the timing at which the server device 20 selects a conference room is delayed (for example, five minutes prior to the conference). With such measures, even if an external participant visits the company earlier than the conference time, a waiting place for the external participant can be secured.

In the flow chart (flowchart and sequence diagram) used in the above description, a plurality of steps (processes) are described in order, but the execution order of the steps executed in the example embodiment is not limited to the described order. In the example embodiment, for example, the order of the illustrated steps can be changed within a range in which there is no problem in terms of content, such as executing each process in parallel.

The above example embodiments have been described in detail in order to facilitate understanding of the present disclosure, and it is not intended that all the configurations described above are necessary. In addition, in a case where a plurality of example embodiments has been described, each example embodiment may be used alone or in combination. For example, a part of the configuration of the example embodiment can be replaced with the configuration of another example embodiment, or the configuration of another example embodiment can be added to the configuration of the example embodiment. Furthermore, it is possible to add, delete, and replace other configurations for a part of the configuration of the example embodiment.

Although the industrial applicability of the present invention is apparent from the above description, the present invention can be suitably applied to a conference room management system that manages a conference room of a company or the like.

Some or all of the above example embodiments may be described as the following supplementary notes, but are not limited to the following.

### [Supplementary Note 1]

A server device including: a conference reservation database that stores a date and time of a conference, IDs of participants participating in the conference, and contact information of the participants in association with each other; a conference room management unit that selects a conference room to be used for the conference from among a plurality of conference rooms before the date and time of the conference, and notifies the participants of an ID of the selected conference room; and an authentication request processing unit that receives an authentication request related to a visitor of the selected conference room from a terminal that controls entrance and exit into and from the selected conference room, processes the received authentication request, and transmits an authentication result related to the visitor to the terminal.

### [Supplementary Note 2]

The server device according to Supplementary Note 1, further including: a user database that stores biometric information and an ID of each of a plurality of users in association with each other, wherein the authentication request includes biometric information of the visitor, and the authentication request processing unit determines whether the visitor has authority to use the selected conference room by collation processing using the biometric information extracted from the authentication request and the biometric information stored in the user database.

[Supplementary Note 3] The server device according to Supplementary Note 2, wherein the authentication request processing unit specifies an ID of the visitor by collation processing using the biometric information extracted from the authentication request and the biometric information stored in the user database, and determines that the visitor has authority to use the selected conference room when the specified ID of the visitor is stored in the conference reservation database.

### [Supplementary Note 4]

The server device according to Supplementary Note 3, wherein the authentication request processing unit notifies the terminal of successful authentication when determining that the visitor has authority to use the selected conference room, and notifies the terminal of failed authentication when determining that the visitor does not have authority to use the selected conference room.

[Supplementary Note 5] The server device according to any one of Supplementary Notes 1 to 4, wherein the conference room management unit selects a conference room to be used for the conference from among the plurality of conference rooms based on the number of participants participating in the conference.

### [Supplementary Note 6]

The server device according to any one of Supplementary Notes 1 to 5, wherein the conference room management unit selects a conference room capable of accommodating participants participating in the conference among the plurality of conference rooms.

### [Supplementary Note 7]

A conference room management system including: a terminal configured to control entrance and exit into and from a conference room; and a server device connected to the terminal, the server device including: a conference reservation database that stores a date and time of a conference, IDs of participants participating in the conference, and contact information of the participants in association with each other; a conference room management unit that selects a conference room to be used for the conference from among a plurality of conference rooms before the date and time of the conference, and notifies the participants of an ID of the selected conference room; and an authentication request processing unit that receives an authentication request related to a visitor of the terminal from the terminal, processes the received authentication request, and transmits an authentication result related to the visitor to the terminal.

### [Supplementary Note 8]

The conference room management system according to Supplementary Note 7, further including: a user database that stores biometric information and an ID of each of a plurality of users in association with each other, wherein the authentication request includes biometric information of the visitor, and the authentication request processing unit determines whether the visitor has authority to use the selected conference room by collation processing using the biometric information extracted from the authentication request and the biometric information stored in the user database.

### [Supplementary Note 9]

The conference room management system according to Supplementary Note 8, wherein the authentication request processing unit specifies an ID of the visitor by collation processing using the biometric information extracted from the authentication request and the biometric information stored in the user database, and determines that the visitor has authority to use the selected conference room when the specified ID of the visitor is stored in the conference reservation database.

### [Supplementary Note 10]

The conference room management system according to Supplementary Note 9, wherein the authentication request processing unit notifies the terminal of successful authentication when determining that the visitor has authority to use the selected conference room, and notifies the terminal of failed authentication when determining that the visitor does not have authority to use the selected conference room.

### [Supplementary Note 11]

The conference room management system according to any one of Supplementary Notes 7 to 10, wherein the conference room management unit selects a conference room to be used for the conference from among the plurality of conference rooms based on the number of participants participating in the conference.

### [Supplementary Note 12]

The conference room management system according to any one of Supplementary Notes 7 to 11, wherein the conference room management unit selects a conference room capable of accommodating participants who participate in the conference among the plurality of conference rooms.

### [Supplementary Note 13]

A conference room management method in a server device, the method including: storing a date and time of a conference, IDs of participants participating in the conference, and contact information of the participants in association with each other; selecting a conference room to be used for the conference from among a plurality of conference rooms and notifying the participants of an ID of the selected conference room before the date and time of the conference; and receiving an authentication request related to a visitor of the selected conference room from a terminal that controls entrance and exit into and from the selected conference room, processes the received authentication request, and transmits an authentication result related to the visitor to the terminal.

### [Supplementary Note 14]

A computer-readable storage medium storing a program for causing a computer mounted on a server device to execute: a process of storing a date and time of a conference, IDs of participants participating in the conference, and contact information of the participants in association with each other; a process of selecting a conference room to be used for the conference from among a plurality of conference rooms and notifying the participants of an ID of the selected conference room before the date and time of the conference; and a process of receiving an authentication request related to a visitor of the selected conference room from a terminal that controls entrance and exit into and from the selected conference room, processes the received authentication request, and transmits an authentication result related to the visitor to the terminal.

The disclosures of the cited prior art documents are incorporated herein by reference. While the embodiments of the present invention have been particularly shown and described above, the present invention is not limited to these embodiments. It will be understood by those of ordinary skill in the art that these embodiments are exemplary only and that various modifications are possible without departing from the scope and spirit of the invention. That is, it goes without saying that the present invention includes various modifications and corrections that can be made by those skilled in the art in accordance with the entire disclosure including the claims and the technical idea.

### REFERENCE SIGNS LIST

10, 10-1, 10-2 Authentication terminal
20, 100 Server device
30, 30-1, 30-2 Gate
101 Conference reservation database
102, 204 Conference room management unit
103, 205 Authentication request processing unit
201, 301 Communication control unit
202 User registration unit
203 Reservation information management unit
206, 305 Storage unit
211 User information acquisition unit
212 ID generation unit
213 Feature amount generation unit
214 Entry management unit
302 Face image acquisition unit
303 Authentication request unit
304 Authentication result output unit
311 Processor
312 Memory
313 Input/output interface
314 Communication interface

What is claimed is:

1. A server device comprising:
a conference reservation database that stores in association with each other, a date and time of a conference, Identifications(IDs) of participants participating in the conference, and contact information of the participants in association with each other;
one or more memories storing instructions; and
one or more processors configured to execute the instructions to:
select a conference room to be used for the conference from among a plurality of conference rooms before the date and time of the conference, and notifies the participants of an ID of the selected conference room; and
receive an authentication request related to a visitor of the selected conference room from a terminal, the terminal controlling entrance and exit into and from the selected conference room, processes the received authentication request, and transmits an authentication result related to the visitor to the terminal.

2. The server device according to claim 1, further comprising:
a user database that stores in association with each other, biometric information and an ID of each of a plurality of users,
wherein the authentication request includes biometric information of the visitor, and
wherein the one or more processors are configured to execute the instructions to determine whether the visitor has authority to use the selected conference room by collation processing using the biometric information, extracted from the authentication request, and the biometric information stored in the user database.

3. The server device according to claim 2,
wherein the one or more processors are configured to execute the instructions to specify an ID of the visitor by the collation processing using the biometric information, extracted from the authentication request, and the biometric information stored in the user database; and
determine that the visitor has authority to use the selected conference room when the specified ID of the visitor is stored in the conference reservation database.

4. The server device according to claim 3, wherein the one or more processors are configured to execute the instructions to notify the terminal of successful authentication when determining that the visitor has authority to use the selected conference room, and notify the terminal of failed authentication when determining that the visitor does not have authority to use the selected conference room.

5. The server device according to claim 4, wherein the one or more processors are configured to execute the instructions to select a conference room to be used for the conference from among the plurality of conference rooms based on the number of participants participating in the conference.

6. The server device according to claim 5, wherein the one or more processors are configured to execute the instructions to select a conference room capable of accommodating participants participating in the conference among the plurality of conference rooms.

7.-12. (canceled)

13. A conference room management method in a server device, the method comprising:
storing in association with each other, a date and time of a conference, IDs of participants participating in the conference, and contact information of the participants;
selecting a conference room to be used for the conference from among a plurality of conference rooms and notifying the participants of an ID of the selected conference room before the date and time of the conference; and
receiving an authentication request related to a visitor of the selected conference room from a terminal that controls entrance and exit into and from the selected conference room, processing the received authentication request, and transmitting an authentication result related to the visitor to the terminal.

14. A non-transitory computer-readable storage medium stored with a program for causing a computer mounted on a server device to execute:
a process of storing in association with each other, a date and time of a conference, IDs of participants participating in the conference, and contact information of the participants;
a process of selecting a conference room to be used for the conference from among a plurality of conference rooms and notifying the participants of an ID of the selected conference room before the date and time of the conference; and
a process of receiving an authentication request related to a visitor of the selected conference room from a terminal that controls entrance and exit into and from the selected conference room, processing the received authentication request, and transmitting an authentication result related to the visitor to the terminal.
